(19) United States
(12) Patent Application Publication
(10) Pub. No.: US 2024/0045656 A1
(43) Pub. Date: Feb. 8, 2024

(54) METHOD FOR GENERATING RANDOM NUMBER FOR GAMING BASED ON BLOCKCHAIN NETWORK AND GAMING SYSTEM

(71) Applicant: PUFsecurity Corporation, Hsinchu County (TW)

(72) Inventors: Kai-Hsin Chuang, Hsinchu County (TW); Yu-Hsin Wang, Hsinchu County (TW)

(73) Assignee: PUFsecurity Corporation, Hsinchu County (TW)

(21) Appl. No.: 18/227,316

(22) Filed: Jul. 28, 2023

Related U.S. Application Data
(60) Provisional application No. 63/395,330, filed on Aug. 4, 2022.

(51) Int. Cl. G06F 7/58

(52) U.S. Cl. CPC G06F 7/58

(57) ABSTRACT

A method for generating random numbers for gaming based on a blockchain network is provided, which includes generating and broadcasting a random number request packet to the blockchain network by a game server of the blockchain network in response to occurrence of a random event in gaming, generating a plurality of random numbers by a plurality of random number supplier nodes of the blockchain network in response to receiving the random number request packet, determining if the respective generated random number conforms to a selection criterion by the plurality of random number supplier nodes, adding an added block corresponding to a first valid random number to the blockchain network by one of the random number supplier nodes and obtaining a target random number corresponding to the added block by the game server.

### CROSS REFERENCE TO RELATED APPLICATIONS

This application claims the benefit of U.S. Provisional Application No. 63/395,330, filed on Aug. 4, 2022. The content of the application is incorporated herein by reference.

### BACKGROUND OF THE INVENTION

### 1. Field of the Invention

The present invention relates to a method for generating random number for gaming based on blockchain network and a gaming system, and more particularly, to a method for generating random number for gaming based on blockchain network and a gaming system capable of providing fair and trusted random number.

### 2. Description of the Prior Art

Random numbers are widely used in various applications such as cryptography, gaming, simulations, and statistical analysis. Random numbers play a significant role in games. For example, randomly chosen items or values are important in many games. The random numbers maybe used in game development to create random events, such as game draw, items players pick up, whether an attack lands. In general, random number generators may be used to generate a sequence of unpredicted and independent numbers. The random number generators may be classified into two main types: software-based and hardware-based. The software-based random number generators usually lack enough entropy and true randomness, which make the generated random number vulnerable to various attacks, such as tampering, predicting the outcomes of games of chance. Besides, software-based random number generators are often operated on specific platforms and may be easily packable and remotely controlled by attack owner, and this could also compromise the fairness of the random numbers. Further, the hardware-based random number generator may generate true random numbers by using physical phenomena, such as thermal noise, radioactive decay, or quantum effects. However, if the game server cheats the game players, and intentionally requests the random number generator to generate random numbers multiple times for cherry-picking the desired results. This may result in an unfair and distrusted random number generating process. Thus, the prior art has to be improved.

### SUMMARY OF THE INVENTION

It is therefore an objective of the present invention to provide a method for generating random number for gaming based on blockchain network and a gaming system capable of providing fair and trusted random number, to solve the abovementioned problem.

An embodiment of the present invention discloses a method for generating random numbers for gaming based on a blockchain network, comprising: generating and broadcasting, by a game server of the blockchain network, a random number request packet to the blockchain network in response to occurrence of a random event in gaming; generating, by a plurality of random number supplier nodes of the blockchain network, a plurality of random numbers in response to receiving the random number request packet; determining, by the plurality of random number supplier nodes, if the respective generated random number conforms to a selection criterion; adding, by one of the random number supplier nodes, an added block corresponding to a first valid random number to the blockchain network; and obtaining, by the game server of the blockchain network, a target random number corresponding to the random number request packet from the plurality of valid random number packets.

An embodiment of the present invention discloses a gaming system, applied in a blockchain network, comprising: a game server, connected to the blockchain network, configured to generate a random number request packet in response to occurrence of a random event in gaming and broadcast the random number request packet to the blockchain network; and a plurality of random number supplier nodes, connected to the blockchain network, configured to generate a plurality of random numbers in response to receiving the random number request; wherein an added block corresponding to a first valid random number conforming to a selection criterion, creating by one of the random number supplier nodes, is added to the blockchain network, such that the game server obtains a target random number corresponding to the added block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of decentralized gaming system according to an embodiment of the present invention.

FIG. 2 is a schematic diagram illustrating an example of a product certificate of the random number supplier node according to an embodiment of the present invention.

FIG. 3 is a flow diagram of a procedure according to an embodiment of the present invention.

FIG. 4 is a schematic diagram illustrating an example of a packet format of a random number request packet according to an embodiment of the present invention.

FIG. 5 is a schematic diagram illustrating an example of a packet format of a random number packet according to an embodiment of the present invention.

FIG. 6 is a schematic diagram illustrating an example of an added block of the blockchain network according to an embodiment of the present invention.

### DETAILED DESCRIPTION

Certain terms are used throughout the description and following claims to refer to particular components. As one skilled in the art will appreciate, hardware manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”.

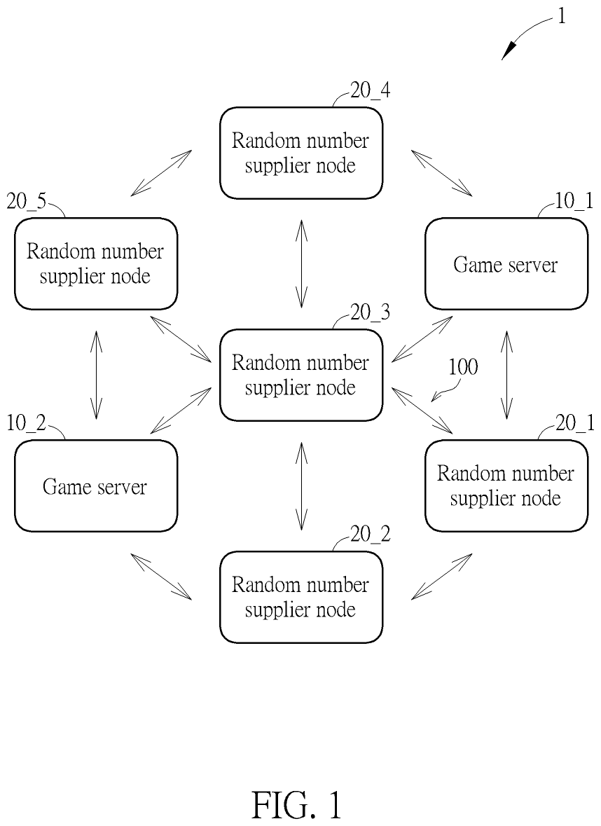

Please refer to FIG. 1, which is a schematic diagram of decentralized gaming system 1 according to an embodiment of the present invention. The gaming system 1 may be applied in a blockchain network 100. The blockchain network 100 may include one or more communication networks. The blockchain network 100 may include a local area network (LAN), wide area network (WAN), Internet, or a combination thereof, but not limited thereto. The blockchain network may be accessed over a wired and/or a wireless communications link. The gaming system 1 includes game servers 10_1-10_2 and random number supplier nodes 20_1-20_5. The number of the game servers and random number supplier nodes may be varied and designed according to practical system demands. The game servers 10_1-10_2 and random number supplier nodes 20_1-20_5 may be node devices of the blockchain network 100. The game servers 10_1-10_2 may be connected to the blockchain networks 100. Each game server may be directly or indirectly connected to any node in the blockchain network 100 to access data. The game server may be configured to generate a random number request packet in response to occurrence of a random event in gaming and broadcast the random number request packet to the blockchain network 100. The game server may obtain a target random number corresponding to the random number request packet via the blockchain network 100 and apply the target random numbers to execute random events.

The random number supplier nodes 20_1-20_5 may be connected to the blockchain network 100. The random number supplier nodes 20_1-20_5 are configured to generate a plurality of random numbers in response to receiving the random number request packet. Each random number supplier node may include a registered public key, a corresponding private key and a product certificate. Since the random number supplier node may be applied in gaming, a random number generating source with sufficient fairness and randomness is essential for games to ensure that the results or outcomes of the games are fair and trusted. For example, each random number supplier node may include a certified true random number generator for generating random numbers, and the product certificate of the random number supplier node maybe issued by a manufacturer of the certified true random number generator.

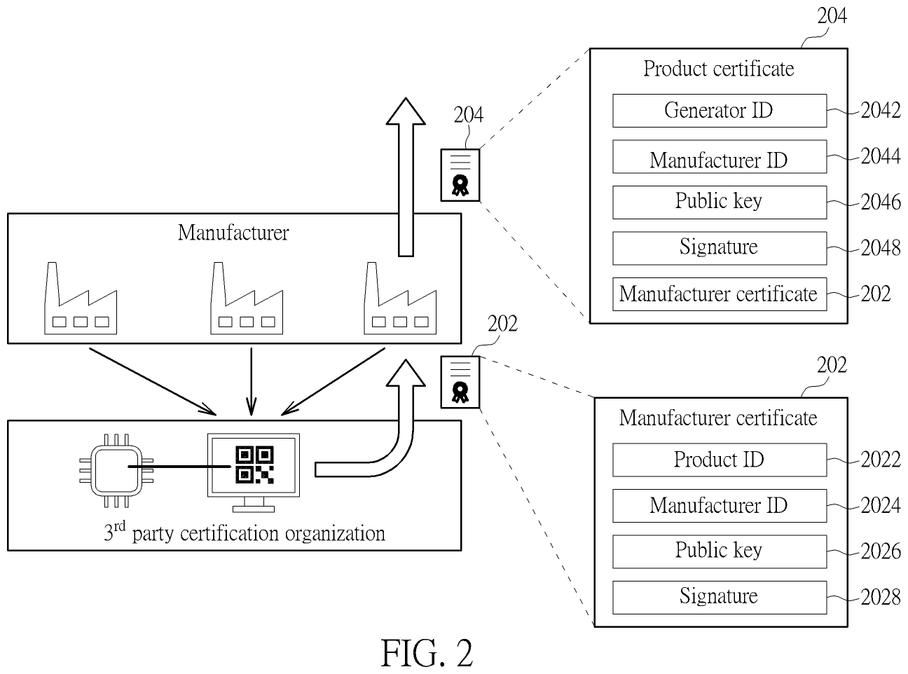

Please refer to FIG. 2. FIG. 2 is a schematic diagram illustrating an example of a product certificate of the random number supplier node according to an embodiment of the present invention. For each certified true random number generator, the manufacturer of the certified true random number generator may send a sample product of a true random number generator to a trusted third-party certification organization for certification before manufacturing the certified true random number generator. After verifying that the sample product of the true random number generator meets a specific standard or other technical specifications, the trusted third-party certification organization may issue a manufacturer certificate 202 signed by the private key of the third-party certification organization. The manufacturer certificate 202 may be utilized for identifying that the manufacturer is a valid manufacturer of manufacturing true random number generators.

Please further refer to FIG. 2. The manufacturer certificate 202 may include a product identifier (ID) 2022, a manufacturer ID 2024, a public key 2026 and a signature 2028. The public key 2026 represents the public key of the manufacturer. The signature 2028 may be generated by signing the public key 2026 of the manufacturer by using the private key of the third-party certification organization. After being certified by third-party certification organization, the public key 2026 of the manufacturer may be signed by using the private key of the third-party certification organization to generated the signature 2028 in the manufacturer certificate 202 to help ensure that the manufacturer is a valid manufacturer and capable of manufacturing true random number generators. The manufacturer of the true random number generator may manage the certificate database of its sold products. When the manufacturer produces a true random number generator and the entropy quality of the true random number generator is proven, the manufacturer may issue a product certificate 204 signed by the private key of the manufacturer for the true random number generator. The product certificate 204 may be utilized for identifying that the true random number generator is capable of generating true random numbers. The term “true random number” may refer to a bit stream that is substantially 50% in a hamming weight, and is substantially 1 in a min-entropy. The hamming weight measures an expected value of non-zero symbols in the bit stream in a percentage form. The min-entropy is a lower bound of entropy of the bit stream, measuring unpredictability of the bit number stream. Through the product certificate 204 issued by the manufacturer, the true random number generator may be recognized as a certified true random number generator.

The product certificate 204 may include a generator ID 2042, a manufacturer ID 2044, a public key 2046 and a signature 2048. The generator ID 2042 represents the identifier of the true random number generator. The public key 2046 represents the public key of the true random number generator. The signature 2048 may be generated by signing the public key 2046 of the true random number generator by using the private key of the manufacturer. The product certificate 204 may further include part or all contents of the manufacturer certificate 202. For example, the product certificate 204 may at least include the signature 2028 of the manufacturer certificate 202.

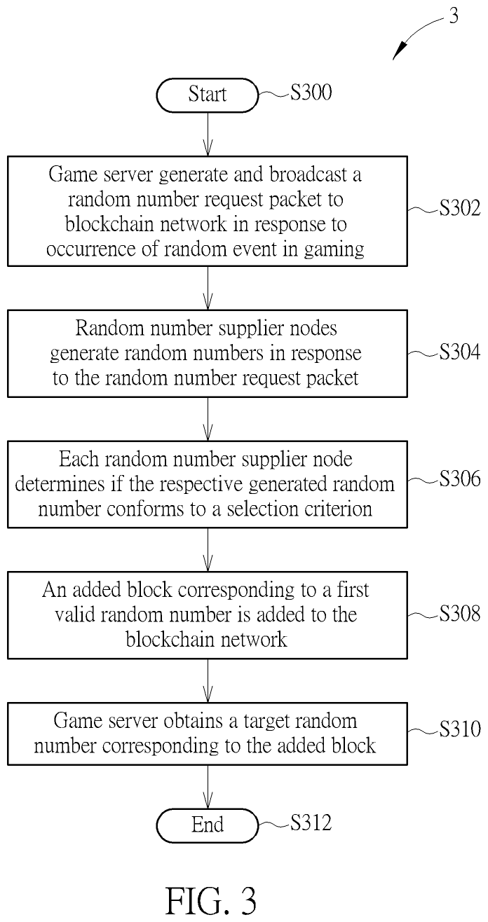

For an illustration of the operations of the gaming system 1, please refer to FIG. 3. FIG. 3 is a flow diagram of a procedure 3 according to an embodiment of the present invention. The procedure 3 includes the following steps:
Step S300: Start.
Step S302: Game server generate and broadcast a random number request packet to blockchain network in response to occurrence of random event in gaming.
Step S304: Random number supplier nodes generate random numbers in response to the random number request packet.
Step S306: Each random number supplier node determines if the respective generated random number conforms to a selection criterion
Step S308: An added block corresponding to a first valid random number is added to the blockchain network.
Step S310: Game server obtains a target random number corresponding to the added block.
Step S312: End.

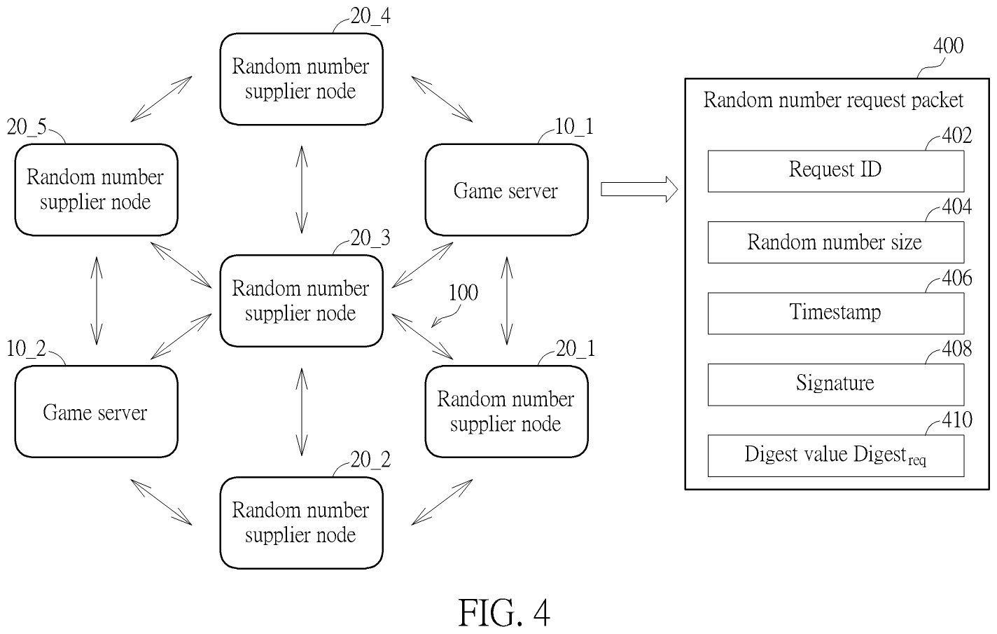

According to the procedure 3, in Step S302, when a random event is triggered in gaming, a random number is required for the random event. For example, a random event (e.g., a game draw) is encountered in gaming. Assuming that a random integer may be generated in the range from one to one hundred. When the obtained random integer is larger than ninety, the game player wins a prize. In response to occurrence of the random event in gaming, the game server (e.g., game server 10_1) may generate a random number request packet and broadcast the random number request packet to the blockchain network 100. Please refer to FIG. 4. FIG. 4 is a schematic diagram illustrating an example of a packet format of a random number request packet 400 according to an embodiment of the present invention. The random number request packet 400 may include a request ID 402, a random number size 404, a timestamp 406, a signature 408, and a digest value Digest_{req} 410. The request ID 402 may be associated with the random event. The signature 408 may be generated by signing the request ID 402 by using the private key of the game server generating the random number request packet. The digest value Digest_{req} 410 represents the digest value of the random number request packet. The random number request packet 400 may also include a selection criterion shown in the following.

In Step S304, the random number supplier nodes 20_1-20_5 are configured to generate a plurality of random numbers in response to receiving the random number request packet. The random number supplier nodes 20_1-20_5 are distributed across the blockchain network 100 such that the random number supplier nodes 20_1-20_5 may receive the random number request packet broadcasted by the game server. For each random number supplier node in the blockchain network 100, when receiving the random number request packet, the random number supplier node may generate a random number according to the random number request packet.

In Step S306, each random number supplier node receiving the random number request packet determines if the respective generated random number conforms to a selection criterion. After generating the random numbers in Step S304, each random number supplier node may determine whether the respective generated random number satisfies a selection criterion. The selection criterion the random number supply node used to determine if the generated random number conforms to is descripted in detail as below. The selection criterion may be associated with a digest value of the generated random number Digestᵣₙ, a digest value of the random number request packet Digest_{req} and a threshold value TH. For example, the digest value of the generated random number Digestᵣₙ may be a hash value of the generated random number calculated based on a hash function. The digest value of the random number request packet Digest_{req} may be a hash value of the random number request packet calculated based on the hash function. For example, the hash values of the random number and the random number request packet may be calculated by using a hash function, such as secure hashing algorithm 1 (SHA-1), SHA-256, SHA-384, SHA-512, but not limited thereto. In an embodiment, the selection criterion may be expressed as follows:

|Digest_{req}−Digestᵣₙ|≤TH

Where Digest_{req} represents the digest value of the random number request packet, Digestᵣₙ represents the digest value of the generated random number, and TH represents the threshold value.

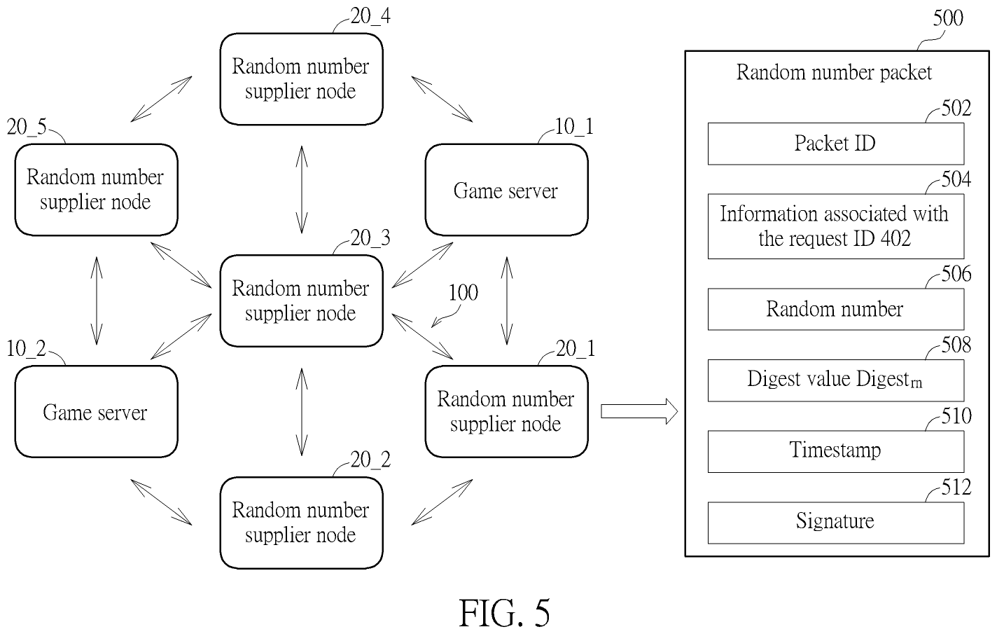

In a word, assume there are numbers of random number supplier node receiving the random number request packet broadcasted from the game server, each random number supplier nodes will determine if the respective generated random number conforms to the preset selection criterion. When determining that the generated random number satisfies the selection criterion, the random number supplier node may create a random number packet corresponding to the generated random number and broadcast the random number packet to the blockchain network 100. Please refer to FIG. 5. FIG. 5 is a schematic diagram illustrating an example of a packet format of a random number packet 500 according to an embodiment of the present invention. Each random number supplier node may create a random number packet corresponding to the respective generated random. number. The random number packet 500 may include a packet ID 502, information 504 associated with the request ID 402, a random number 506, a digest value Digestᵣₙ 508, a timestamp 510, and a signature 512. The packet ID 502 represents the identifier of the random number packet 500. The information 504 represents information associated with the request ID 402 broadcasted by the game server. The information 504 may include part or all of contents of the random number request packet 400. For example, the information 504 may include the request ID 402, the digest value Digest_{req} 410 in the random number request packet 400 and the selection criterion. The random number 506 represents the random number generated by the random number supplier node. The digest value Digestᵣₙ 508 represents the digest value of the random. number 506. The signature 512 may be generated by signing the random number 506 using the private key of the random number supplier node generating the random number 506.

In Step S308, an added block corresponding to a first valid random number is added to the blockchain network. For example, there may be at least one random number packet generated based on satisfying the selection criterion and the at least one random number packet may be broadcasted to the blockchain network 100. Each random number packet may be regarded as transaction which needs to be validated by other nodes of the blockchain network 100. All nodes of the blockchain network 100 will reach a consensus that which random number packet is firstly validated. It is to be noted that before validating the random number packet, each node in the blockchain network will also determine if the broadcasted random number included in the random number packet satisfy the preset selection criterion. The blockchain network then reach a consensus on if the random number included in the respective random number packet is a first valid random number. Thereafter the validated random number packet including the first valid random number will be added to the ledger of each blockchain node. After each node within the blockchain network has added the validated random number packet into their ledger, a block corresponding to the first valid random number is added into the blockchain.

In summary, the random number included in the first validated random number packet is determined to be a first valid random number. That is, an added block corresponding to the first valid random number (i.e., the random number packet being first verified to be valid) may be created to the existing blockchain of the blockchain network 100. The added block may include information associated with the corresponding first validated random number packet. In addition, the added block may include some part or all of contents of the first validated random number packet.

As the added block corresponding to the first valid random number is added to the blockchain, the random number generating procedure of the random number request packet is finished. In other words, once random number supplier nodes update their ledger with the added block, they will stop generating random numbers until a next random number request is received. However, due to network latency, some random number supplier nodes may generate and broadcast random number packets conforming to the present criterion before they receive the added block corresponding to the first valid random number. In such a case, the blockchain network must reach a consensus on which block is the first added block. The first validated random number packet can be determined after the consensus is reached. A consensus mechanism must be chosen when establishing the blockchain network, for example, the added block firstly received by a majority of blockchain nodes will be determined as the official first added block. In this way, every random number supplier node has a chance to create the first valid random number, and there will be only one official first added block corresponding to the first valid random number in the blockchain. As such, the game server cannot predict or decide which random number generator node will generate the first valid random number. Also, since the added block corresponding to the first valid random number is stored in the ledger of each blockchain nodes, the first valid random number is publicly verifiable and unchangeable.

In Step S310, the game server 10 may obtain a target random number corresponding to the added block. As the added block which includes the first valid random number is added to the blockchain. The game server may obtain a target random number corresponding to the random number request packet from the added block corresponding to the first valid random number and apply the target random number to execute the random event. For example, the game server may obtain the first valid random number of the first validated random number packet for acting as the target random number corresponding to the random number request packet, and apply the target random number to execute the random event.

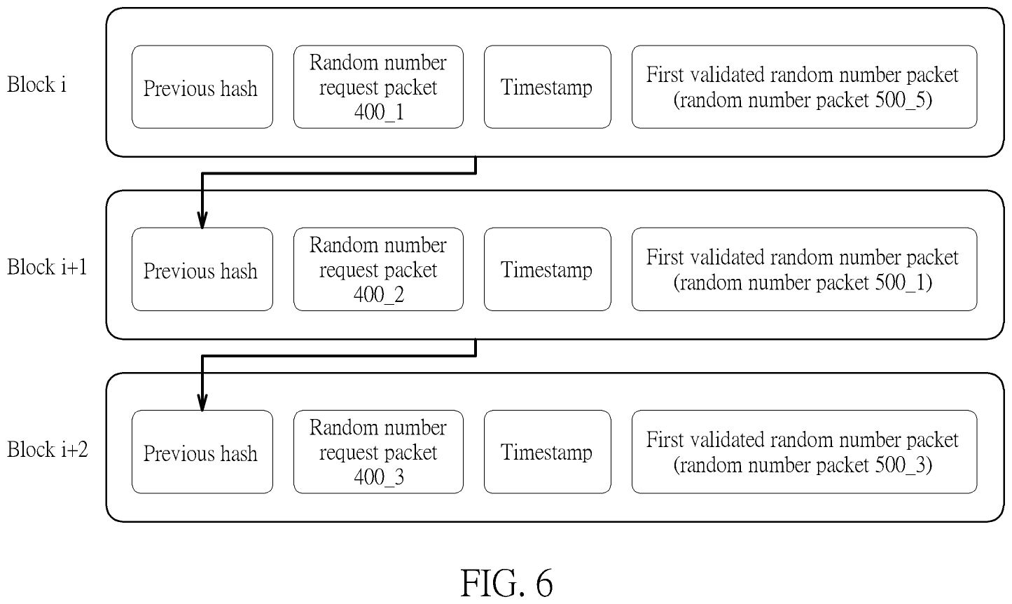

For example, please refer to FIG. 6. FIG. 6 is a schematic diagram illustrating an example of added blocks of the blockchain network 100 according to an embodiment of the present invention. A random number request packet 400_1 is broadcasted to the blockchain network 100 (Step S302), and random number packets 500_3, 500_4 and 500_5 generated respectively by the random number supplier nodes 20_3-20_5 based on satisfying the selection criterion of random number request packet 400_1, and the random number packets 500_3, 500_4 and 500_5 are broadcasted to the blockchain network 100 (Steps S304 and S306). The blockchain network then reaches a consensus on determining the random number packet 500_5 as the first validated random number packet. As the random number packet 500_5 is verified to be valid first by other nodes of the blockchain network 100, such that the random number packet 500_5 is determined as the first validated random number packet corresponding to the random number request packet 400_1. Accordingly, an added block (block i) corresponding to the random number packet 500_5 and the random number request packet 400_1 may be created to the existing blockchain of the blockchain network 100. The added block may include some part or all of contents of the random number packet 500_5 (i.e., first validated random number packet corresponding to the random number request packet 400_1). As shown in FIG. 6, the block i of the blockchain may include a previous hash representing a hash value of the previous block (i.e., block (i−1)), the random number request packet 400_1, a timestamp and the random number packet 500_5 (i.e., first validated random number packet corresponding to the random number request packet 400_1). The random number packet 500_5 may include a first valid random number 506_5 generated by the random number supplier node 20_5 and conforming to the selection criterion of random number request packet 400_1. The game server may obtain the first valid random number 506_5 included in the first validated random number packet 500_5 of block i for acting as the target random number corresponding to the random number request packet 400_1 and apply the target random number to execute the random event.

Therefore, in the gaming system 1, each random number supplier node in the blockchain network 100 may generate random numbers. Once an added block corresponding to the first valid random number is added to the blockchain and the blockchain network has reached a consensus on determining it as the official added block, the game server obtains a target random number corresponding to the first valid random number. For setting an appropriate threshold, each random number generated by the random number supplier node has the same probability to satisfy the selection criterion, such that the game server cannot intentionally select or assign a dedicated random number supplier node to generate the random number and the procedure of generating the random number cannot be tampered. The game server cannot control or manipulate the random number generation process and there is no chance of cherry-picking the generated random numbers. As a result, the embodiments of the present invention provide fair and trusted random numbers thus improving the fairness and trust in gaming.

Moreover, please further refer to FIG. 6, as the abovementioned embodiments, the random number request packet 400_1 is broadcasted to the blockchain network 100 and random number packets 500_3, 500_4, 500_5 are generated and broadcasted to the blockchain network 100 based on satisfying the selection criterion of random number request packet 400_1. The random number packet 500_5 is first verified to be valid, and chosen as the first validated random number packet corresponding to the random number request packet 400_1. The added block (block i) corresponding to the random number packet 500_5 may be created to the existing blockchain of the blockchain network 100. As the added block corresponding to the random number packet 500_5 (i.e., the random number packet being first verified to be valid), there is no other added block to be created for the random number request packet 400_1 due to the property of blockchain. Even if the other random number packet (i.e., random number packet 500_3 or 500_4) corresponding to the random number request packet 400_1 is verified to be valid later, only one added block will be determined as the official added block according to the consensus mechanism. The game server may obtain the random number 506_5 included in the random number packet 500_5 of block i for acting as the target random number corresponding to the random number request packet 400_1 and apply the target random number to execute the random event.

After that, when a next random number request packet 400_2 is broadcasted to the blockchain network 100, a random number packet 500_1 is generated by the random number supplier node 20_1 and a random number packet 500_2 is generated by the random number supplier node 20_2 based on satisfying the selection criterion of random number request packet 400_2. The random number packets 500_1 and 500_2 are broadcasted the blockchain network 100. The random number packet 500_1 is verified to be valid (validated) first by the majority of blockchain nodes, such that the random number packet 500_1 is determined as the first validated random number packet corresponding to the random number request packet 400_2. As shown in FIG. 6, an added block (block (i+1)) corresponding to the first validated random number packet 500_1 and the random number request packet 400_2 may be created to the existing blockchain of the blockchain network 100. The block (i+1) of the blockchain may include a previous hash representing a hash value of the previous block (i.e., block i), the random number request packet 400_2, a timestamp and the random number packet 500_1 (i.e., first validated random number packet corresponding to the random number request packet 400_2). The random number packet 500_1 may include a first valid random number 506_1 generated by the random number supplier node 20_1 and conforming to the selection criterion of random number request packet 400_2. The game server may obtain the first valid random number 506_1 included in the first validated random number packet 500_1 of block (i+1) for acting as the target random number corresponding to the random number request packet 400_2 and apply the target random number to execute the random event.

Similarly, when a random number request packet 400_3 is broadcasted to the blockchain network 100, the random number packets 500_2, 500_3 and 500_4 are generated by the random number supplier nodes 20_2-20_4 based on satisfying the selection criterion of random number request packet 400_3. The random number packets 500_2, 500_3 and 500_4 are broadcasted to the blockchain network 100. As shown in FIG. 6, the random number packet 500_3 is verified to be valid (validated) first, and an added block (block (i+2)) corresponding to the random number packet 500_3 and the random number request packet 400_3 may be created to the existing blockchain of the blockchain network 100. The block (i+2) of the blockchain may include a previous hash representing a hash value of the previous block (i.e., block (i+1)), the random number request packet 400_3, a timestamp and the random number packet 500_3 (i.e., first validated random number packet corresponding to the random number request packet 400_3). The first validated random number packet 500_3 may include a first valid random number 506_3 generated by the random number supplier node 20_3 and conforming to the selection criterion of random number request packet 400_3. The game server may obtain the first valid random number 506_3 included in the first validated random number packet 500_3 of block (i+2) for acting as the target random number corresponding to the random number request packet 400_3 and apply the target random number to execute the random event.

Moreover, after obtaining the target random number, the game server applies the target random number to execute the random event and a result of the random event may be determined by using the target random number. Since information of the generated random numbers is recorded in the blocks of the distributed ledger, the results may be verified, such that the game player or the game server may be allowed to verify whether the result and outcome of the random event is correct and fair.

For example, the first valid random. number 506_5 of the first validated random number packet 500_5 included in the block i has been chosen as the target random number, the random number 506_5 (i.e., target random number) has been applied to execute the random event. Similar with the aforementioned valid random number packet 500 shown in FIG. 5, suppose the valid random number packet 500_5 includes a packet ID 502_5, information 504_5 associated with the random number request packet, a random number 506_5, a digest value Digestᵣₙ 508_5, a timestamp 510_5, and a signature 512_5. If the game player or the game server wants to verify whether the result and outcome of the random event is correct and fair. First, the game player or the game server may determine which random number supplier node generated the random number 506_5. When determining that the random number 506_5 is generated the random number supplier node 20_5 (i.e., target random number supplier node), the game player or the game server may obtain the public key of the random number supplier node 20_5, and utilize the public key of the random number supplier node 20_5 to verify the signature 512_5 signed by the private key of the random number supplier node 20_5, so as to ensure that the random number 506_5 is generated by the target random number supplier node 20_5. If the signature 512_5 is verified to be valid, this means that the random number 506_5 is generated by the random number supplier node 20_5.

Moreover, each random number supplier node may include a registered public key, a corresponding private key and a product certificate. Please further refer to FIG. 2. The game player or the game server may verify a product certificate of the random number supplier node 20_5. The game player or the game server may obtain the public key of the manufacturer generating the random number supplier node 20_5. The game player or the game server may verify the product certificate of the random number supplier node 20_5 by using the public key of the manufacturer of the random number supplier node 20_5, so as to ensure that the product certificate of the random number supplier node 20_5 is issued by the manufacturer of the random number supplier node 20_5. The game player or the game server may also utilize the public key of the manufacturer generating the random number supplier node 20_5 to verify the signature (e.g., signature 2048 of the product certificate 204) signed by the private key of the manufacturer of the random number supplier node 20_5 in the product certificate, to ensure that the product certificate of the random number supplier node 20_5 is issued by the manufacturer of the random number supplier node 20_5. If the product certificate or the signature (e.g., signature 2048 of the product certificate 204) in the product certificate of the random number supplier node 20_5 is verified to be valid, this means that the random number supplier node 20_5 is manufactured by the manufacturer.

Further, the game player or the game server may verify a manufacturer certificate of the manufacturer of the random number supplier node 20_5. The game player or the game server may obtain the public key of the trusted third-party certification organization, and utilize the public key of the trusted third-party certification organization to verify the manufacturer certificate of the manufacturer of the random number supplier node 20_5 so as to ensure that the manufacturer certificate is certified by the trusted third party. If the manufacturer certificate of the manufacturer of the random number supplier node 20_5 is verified to be valid, this means that the manufacturer of the random number supplier node 20_5 is exactly a certified valid manufacturer capable of manufacturing true random number generator. As such, the random number 506_5 (i.e., target random number) generated by the random number supplier node 20_5 should be fairness and trust random number.

To sum up, under the blockchain network mechanism, random numbers may be generated by the random number supplier nodes distributed across the blockchain network. Since the blockchain network is decentralized, every node in the blockchain network is able to validate the valid random number packet. There is no way to predict which node in the blockchain network will execute and complete the validation of the valid random number packet. As such, the game server cannot control or manipulate the random number generation process. Therefore, the embodiments of the present invention provide fair and trusted random numbers for improving the fairness and trust in gaming. Moreover, the embodiments of the present invention also provide the verifiable random numbers which may guarantee fairness and assurance in games.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for generating random numbers for gaming based on a blockchain network, comprising:
generating and broadcasting, by a game server of the blockchain network, a random number request packet to the blockchain network in response to occurrence of a random event in gaming;
generating, by a plurality of random number supplier nodes of the blockchain network, a plurality of random numbers in response to receiving the random number request packet;
determining, by the plurality of random number supplier nodes, if the respective generated random number conforms to a selection criterion;
adding, by one of the random number supplier nodes, an added block corresponding to a first valid random number to the blockchain network; and
obtaining, by the game server of the blockchain network, a target random number corresponding to the added block.

2. The method of claim 1, wherein the step of determining, by the plurality of random number supplier nodes, if the respective generated random number conforms to the selection criterion comprises:
for each random number supplier node, determining, if the respective generated random number conforms to the selection criterion; and
when determining that the respective generated random number satisfies the selection criterion, generating a random number packet corresponding to the respective generated random number to the blockchain network.

3. The method of claim 2, wherein the selection criterion is that an absolute difference between a digest value of the each generated random number and a digest value of the random number request packet is smaller than or equal to a threshold value.

4. The method of claim 3, wherein the digest value of the each generated random number is a hash value of the each generated random number calculated based on a hash function, and the digest value of the random number request packet is a hash value of the random number request packet calculated based on the hash function.

5. The method of claim 2, wherein the step of adding, by one of the random number supplier nodes, the added block corresponding to the first valid random number to the blockchain network comprises:
broadcasting at least one random number packet generated based on satisfying the selection criterion to the blockchain network; and
when one of the at least one random number packet is first verified to be valid, adding the added block corresponding to the first valid random number included in the first validated random number packet.

6. The method of claim 1, wherein the step of obtaining, by the game server of the blockchain network, the target random number corresponding to the added block comprises:
obtaining, by the game server, the first valid random number of the first validated random number packet included in the added block for acting as the target random number corresponding to the random number request packet.

7. The method of claim 1, further comprising:
for each random number supplier node, signing the random number generated by the each random number supplier node using a private key of the each random number supplier node to generate a first signature associated with the random number and the each random number supplier node.

8. The method of claim 7, further comprising:
determining that a target random number supplier node of the plurality of random number supplier nodes generates the target random number; and
verifying the first signature associated with the target random number and the target random number supplier node using a public key of the target random number supplier node.

9. The method of claim 8, further comprising:
verifying a product signature included in a certificate associated with a manufacturer of the target random number supplier node using a public key of the manufacturer of the target random number supplier node.

10. The method of claim 9, further comprising:
verifying a manufacturer signature signed with the public key of the manufacturer of the target random number supplier node and included in the certificate using a public key associated with a trusted third party.

11. The method of claim 1, wherein the plurality of random number supplier nodes comprise true random number generators.

12. A gaming system, applied in a blockchain network, comprising:
a game server, connected to the blockchain network, configured to generate a random number request packet in response to occurrence of a random event in gaming and broadcast the random number request packet to the blockchain network; and
a plurality of random number supplier nodes, connected to the blockchain network, configured to generate a plurality of random numbers in response to receiving the random number request packet;
wherein an added block corresponding to a first valid random number conforming to a selection criterion, creating by one of the random number supplier nodes, is added to the blockchain network, such that the game server obtains a target random number corresponding to the added block.

13. The gaming system of claim 12, wherein each random number supplier node is configured to determine if the respective generated random number conforms to the selection criterion, and when determining that the respective generated random number satisfies the selection criterion, the random number supplier node is configured to generate a random number packet corresponding to the respective generated random number to the blockchain network.

14. The gaming system of claim 13, wherein the selection criterion is that an absolute difference between a digest value of the each generated random number and a digest value of the random number request packet is smaller than or equal to a threshold value.

15. The gaming system of claim 14, wherein the digest value of the each generated random number is a hash value of the each generated random number calculated based on a hash function, and the digest value of the random number request packet is a hash value of the random number request packet calculated based on the hash function.

16. The gaming system of claim 13, wherein at least random number packet generated based on satisfying the selection criterion is broadcasted to the blockchain network, and when one of the at least one random number packet is first verified to be valid, the random number supplier node generating the first validated random number packet adds the added block corresponding the first valid random number included in the first validated random number packet.

17. The gaming system of claim 12, wherein the game server obtains the first valid random number of the first validated random number packet included in the added block for acting as the target random number corresponding to the random number request packet.

18. The gaming system of claim 12, wherein for each random number supplier node, the random number generated by the random number supplier node is signed by using a private key of the random number supplier node to generate a first signature associated with the random number and the random number supplier node.

19. The gaming system of claim 18, wherein when determining that a target random number supplier node of the plurality of random number supplier nodes generates the target random number, the first signature associated with the target random number and target random number supplier node is verified by using a public key of the target random number supplier node to ensure that the target random number is generated by the target random number supplier node.

20. The gaming system of claim 19, wherein a product signature included in a certificate associated with a manufacturer of the target random number supplier node is verified by using a public key of the manufacturer of the target random number supplier node to ensure that the certificate is issued by the manufacturer of the target random number supplier node.

21. The gaming system of claim 20, wherein a manufacturer signature signed with the public key of the manufacturer of the target random number supplier node and included in the certificate is verified by using a public key associated with a trusted third party to ensure that the certificate is certified by the trusted third party.

22. The gaming system of claim 12, wherein the plurality of random number supplier nodes comprise true random number generators.
